(19) United States
(12) Patent Application Publication
(10) Pub. No.: US 2004/0074466 A1
(43) Pub. Date: Apr. 22, 2004

(54) Integrated intake manifold and air cleaner for engine without a throttle

(75) Inventor: Jeffrey Joseph Powell, Belle River (CA)

Correspondence Address: Elsa Keller, Legal Assistant, Intellectual Property Department, SIEMENS CORPORATION, 186 Wood Avenue South, Iselin, NJ, 08830, US

(73) Assignee: Siemens VDO Automotive Inc.

(21) Appl. No.: 10/664,749

(22) Filed: Sep. 18, 2003

Related U.S. Application Data
(60) Provisional application No. 60/420,073, filed on Oct. 21, 2002.

(51) Int. Cl. F02M 35/10

(52) U.S. Cl. 123/184.42; 123/198 E

(57) ABSTRACT

A module for providing purified air to an internal combustion engine that does not use a throttle body. The module includes a housing an inlet for receiving fresh air and a filter for filtering the fresh air to provide purified air. The module is attached to the engine by at least one mounting member. The module also includes a plurality of runners extending between the housing and the at least one mounting member, wherein the runners direct the purified air to combustion chambers of the engine.

### CROSS REFERENCE TO RELATED APPLICATION AND PRIORITY CLAIM

This application claims the benefit of U.S. Provisional Application No. 60/420,073 (Attorney Docket No. 2002 P 16919 US) filed on Oct. 21, 2002 in the name of Jeffrey Joseph Powell and entitled INTEGRATED INTAKE MANIFOLD AND AIR CLEANER FOR ENGINE WITH NO THROTTLE, which is incorporated by reference herein in its entirety.

### FIELD OF THE INVENTION

This invention relates to air induction systems, and more particularly, to an integrated manifold and air cleaner module for providing purified air to an engine that does not utilize a throttle body.

### BACKGROUND OF THE INVENTION

Internal combustion engines utilize filtered air in order to minimize engine wear. The air is filtered by an air cleaner which is typically located under the hood of a vehicle. The air cleaner includes a filter disposed in a housing having an air intake for receiving outside (dirty) air and an air outlet from which clean air exits. A hose or other conduit is then used to route the clean air to a throttle body which serves to regulate the flow of air to an intake manifold. The intake manifold then distributes the air to all cylinders of the engine in a manner suitable for achieving the proper combustion of fuel.

The throttle body on current engines is located on the intake manifold such that the air is directed to a plenum of the manifold. This is a disadvantage since clearances must be designed into the throttle body area, thus restricting the geometry of the intake manifold. In addition, recent developments in technologies relating to intake valve motion, such as electronic valve timing, variable valve timing and others, have resulted in elimination of the throttle body. As such, there is a need for an integrated intake manifold and air cleaner for engines that do not use a throttle body.

### SUMMARY OF THE INVENTION

A module for providing purified air to an internal combustion engine that does not use a throttle body is disclosed. The module includes a housing having a filter and an inlet for receiving fresh air. The filter removes impurities from the fresh air so as to provide purified air to the engine. The module is attached to the engine by at least one mounting member. The module also includes a plurality of runners extending between the housing and the at least one mounting member, wherein the runners direct the purified air to combustion chambers of the engine.

### BRIEF DESCRIPTION OF THE DRAWINGS

FIG. 1 is an embodiment of an integrated intake manifold and air cleaner module for an internal combustion engine that does not use a throttle body.

FIG. 2 is a side view of the module.

FIG. 3 is an exploded side view of the module.

FIG. 4 is an exploded view of an alternate embodiment of an integrated intake manifold and air cleaner module for an internal combustion engine that does not use a throttle body.

FIG. 5 is an assembled view of the alternate embodiment.

### DETAILED DESCRIPTION OF THE INVENTION

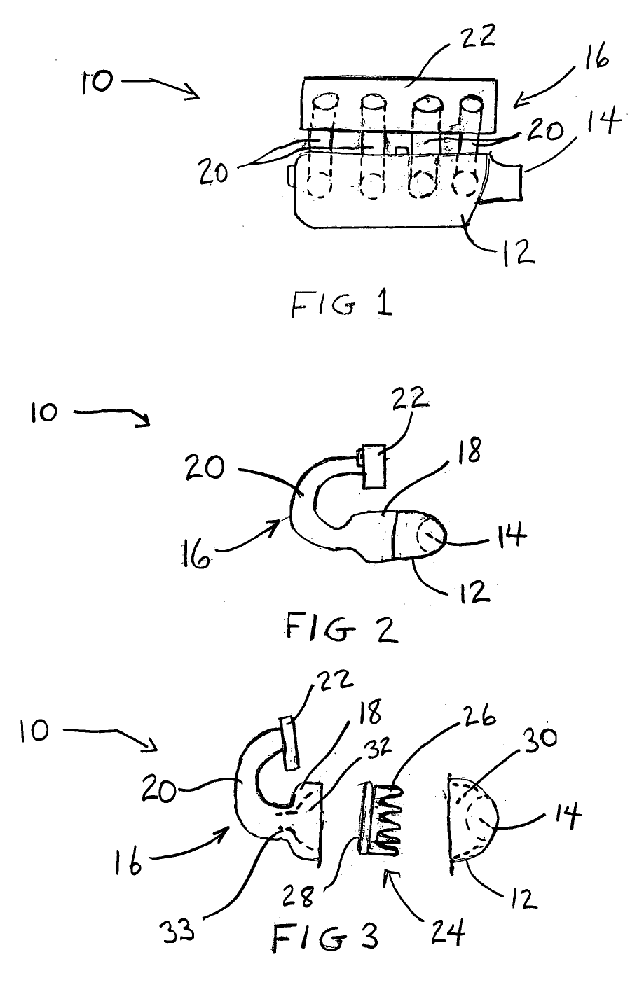

While this invention is susceptible of embodiment in many different forms, there is shown in the drawings and will herein be described in detail specific embodiments, with the understanding that the present disclosure is to be considered as an example of the principles of the invention and not intended to limit the invention to the specific embodiments shown and described. In the description below, like reference numerals are used to describe the same, similar or corresponding parts in the several views of FIGS. 1-5.

Recent developments in technologies relating to intake valve motion, such as electronic valve timing, variable valve timing and others, have resulted in elimination of the throttle body. Referring to FIG. 1, an embodiment of an integrated intake manifold and air cleaner module 10 for an internal combustion engine that does not use a throttle body is shown. In the embodiment shown in FIG. 1, the module 10 is adapted for use with an engine having an in-line cylinder configuration, such as an in-line 4 cylinder engine. The module 10 includes an air filter cover 12 having a fresh air inlet 14 for receiving outside air. A hose or other conduit may be connected to the inlet 14 to facilitate access to outside air. The module 10 further includes a manifold assembly 16 having an upper member 18 which is removably attached to the cover 12. A plurality of hollow tubes or runners 20 extend between the upper member and a mounting member 22. The runners 20 may be generally U-shaped, although it is noted that other configurations may be used. The mounting member 22 is adapted for mounting to a cylinder head portion of an engine. The runners 20 provide fluid communication between the upper member 18 and the combustion chambers of the engine.

Referring to FIG. 3, an exploded view of the module 10 is shown. A removable filter element 24 having filter 26 and base 28 portions is located between the upper member 18 and the cover 12. The filter portion 26 resides within a cavity 30 formed in the cover 12. The base portion 28 is located adjacent a plenum portion 32 formed in the upper member 18. The filter 26 serves to remove impurities such as particles, gases, dirt, pollution and other undesirable substances from incoming air. The filter 26 may be fabricated from paper media in a panel configuration and may include a urethane seal. Alternatively, the filter 26 may be fabricated from synthetic media that is supported by a rigid frame fabricated from plastic which also includes a seal. The cover 12 is selectively removable from the upper member 18 to allow repair, servicing or replacement of the filter 26.

In use, outside air is drawn in through the inlet 14. Impurities in the outside air are then entrapped by the filter 26 to thus provide purified air. The plenum 32 is in fluid communication with the runners 20 and may include a suitable geometry for forming a venturi 33 for optimizing air flow. The purified air is then directed by the plenum 32 and runners 20 to the combustion chambers for use in the combustion process. In accordance with the present invention, the configuration of the module 10 results in an air cleaner portion that is smaller than conventional air cleaners since a hose or other conduit is not required for directing air to a manifold from the air cleaner portion.

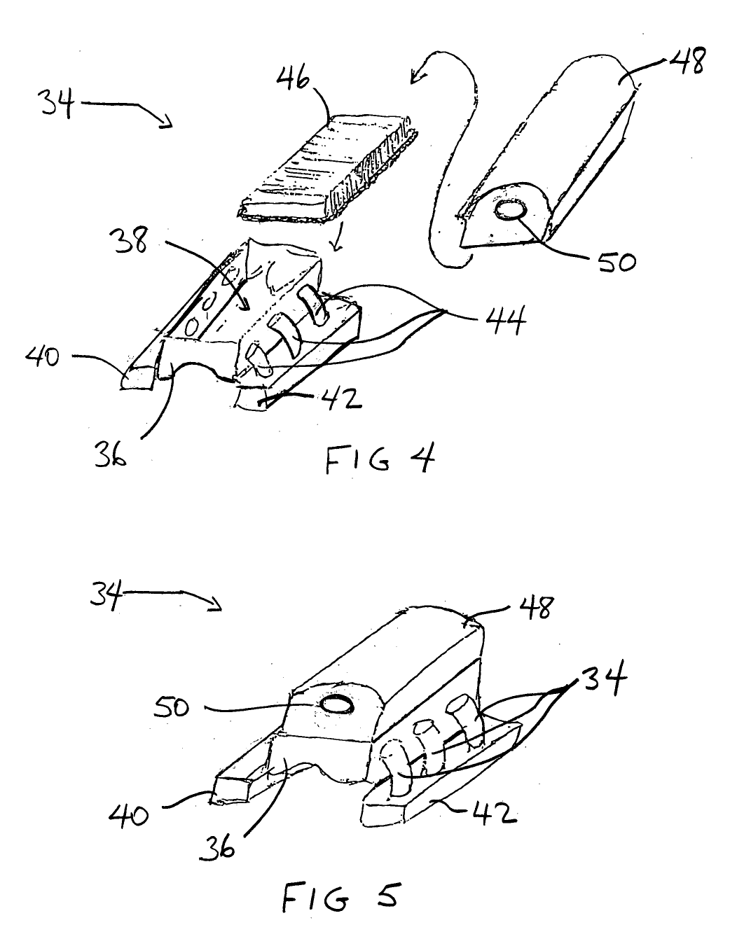

Referring to FIG. 4, an exploded view of an alternate embodiment of a module 34 is shown. As previously described, the module 34 is for use with an internal combustion engine that does not use a throttle body. In this embodiment, the module 34 is adapted for use with engines having cylinders that are arranged in a V configuration thus forming two cylinder heads at a top portion of the V, such as in a V6 or V8 engine. The module 34 includes a generally rectangular shaped housing 36 having a cavity 38. The module 34 also includes first 40 and second 42 mounting members which are adapted to mount to associated cylinder heads. A plurality of runners 44 extend between the housing 36 and the first 40 and second 42 mounting members to provide fluid communication between the cavity 38 and the combustion chambers of the engine.

A removable filter element 46 resides within the cavity 38. The filter 46 is fabricated from materials similar to that described in connection with FIGS. 1-3. An air filter cover 48 is removably attached to the housing to cover the filter 46. The cover 48 includes a fresh air inlet 50 for receiving outside air. An assembled view of the module 34 is shown in FIG. 5.

In use, outside air is drawn in through the inlet 50. Impurities in the outside air are then entrapped by the filter 46 to thus provide purified air. The purified air is then directed by the runners 34 to the combustion chambers for use in the combustion process.

While the invention has been described in conjunction with specific embodiments, it is evident that many alternatives, modifications, permutations and variations will become apparent to those skilled in the art in light of the foregoing description. Accordingly, it is intended that the present invention embrace all such alternatives, modifications and variations as fall within the scope of the appended claims.

What is claimed is:

1. A module for providing purified air to an internal combustion engine that does not use a throttle body, comprising:
a housing having an inlet for receiving fresh air;
a filter for removing impurities from said fresh air to provide purified air, wherein said filter resides in said housing;
at least one mounting member for attaching said module to said engine; and
a plurality of runners extending between said housing and said at least one mounting member, wherein said runners direct said purified air to combustion chambers of said engine.

2. The module according to claim 1, wherein said engine includes a substantially in-line cylinder arrangement.

3. The module according to claim 1, wherein said engine includes a substantially V-shaped cylinder arrangement.

4. The module according to claim 1, wherein said runners are substantially U-shaped.

5. The module according to claim 1, wherein said housing includes a removable cover.

6. The module according to claim 1, wherein said filter element is fabricated from paper media.

7. The module according to claim 1, wherein said filter element is fabricated from synthetic media.

8. The module according to claim 1, wherein said filter element is removable.

9. The module according to claim 1, wherein said housing includes a plenum which is in fluid communication with said runners.

10. The module according to claim 9, wherein said plenum includes a geometry for forming a venturi.

11. An intake manifold and air cleaner module for an internal combustion engine that does not use a throttle body, comprising:
a housing having a filter element, said housing including a fresh air inlet and a plenum;
at least one mounting member for attaching said module to said engine; and
a plurality of runners extending between said plenum and said at least one mounting member, wherein said runners provide fluid communication between said air inlet and said engine.

12. The module according to claim 11, wherein said engine includes a substantially in-line cylinder arrangement.

13. The module according to claim 11, wherein said engine includes a substantially V-shaped cylinder arrangement.

14. The module according to claim 11, wherein said runners are substantially U-shaped.

15. The module according to claim 11, wherein said housing includes a removable cover.

16. The module according to claim 11, wherein said filter element is fabricated from paper media.

17. The module according to claim 11, wherein said filter element is fabricated from synthetic media.

18. The module according to claim 11, wherein said filter element is removable.

19. The module according to claim 11, wherein said plenum includes a geometry for forming a venturi.

20. A method for providing purified air to an internal combustion engine that does not use a throttle body, comprising:
providing a housing an inlet for receiving fresh air;
removing impurities from said fresh air by using a filter to provide purified air; and
providing a plurality of runners for directing said purified air from said housing to combustion chambers of said engine.
